(19) United States
(12) Patent Application Publication
(10) Pub. No.: US 2012/0190315 A1
(43) Pub. Date: Jul. 26, 2012

(54) COMMUNICATIONS SYSTEM FOR A HELMET

(75) Inventors: Abraham Glezerman, Tel-Aviv (IL); Avraham Kushnirov, Or-Yehuda (IL); Yossef Twina, Rosh-Ha'ayin (IL)

(73) Assignee: Cardo Systems, Inc., Pittsburgh, PA (US)

(21) Appl. No.: 13/183,753

(22) Filed: Jul. 15, 2011

Related U.S. Application Data
(63) Continuation-in-part of application No. 13/011,037, filed on Jan. 21, 2011.

(51) Int. Cl. H04W 88/02

(52) U.S. Cl. 455/90.3

(57) ABSTRACT

A communications system is configured to attach to a helmet that includes vent openings formed in an outer shell of the helmet. Components of the system are configured to extend through the openings of the helmet for detachably coupling the components to the helmet. The system can include a main communications module that includes electronic components and a control panel and the system can further include other audio components that include speakers and a microphone. The system also provides the ability to communicate with and/or operate as a digital media player, a radio tuner, a telephone, or a global positioning system (GPS) or another device using Bluetooth technology or other technology.

### CROSS-REFERENCE TO RELATED APPLICATION

The present application is a continuation-in-part of U.S. patent application Ser. No. 13/011,037, filed Jan. 21, 2011, which is hereby incorporated by reference in its entirety.

### TECHNICAL FIELD

The present invention relates to communication systems and more particularly, relates to a communication system that fits within the confines of a helmet which is worn during various activities and provides a wired or wireless connection to at least one component that is associated with the helmet from a separate source of intercommunications or entertainment system that is also associated with the helmet, both components being preferably removable from the helmet.

### BACKGROUND

It will be appreciated that there are number of different types of helmets that are used across many different industries; however, they all are a form of protective gear. For example, wearing hard hats is standard practice when working in a construction site, as well as when operating heavy industrial equipment, etc. Sports athletes, such as baseball and football players, also wear helmets for protection and it is one of the most critical pieces of equipment for a professional race car driver. Helmets are also used in the military services. One type of helmet that is one of the most commonly seen is a bicycle helmet.

In fact, in most states, the wearing of a bicycle helmet is mandatory by law for all riders or at least riders that are less than a certain age. In certain events or situations, such as a group ride or a professional cyclist or policeman cyclist, etc., it would be advantageous for the riders to have the capabilities to communicate amongst each other in a safe manner. Since bicycle riding requires that both hands of the rider be placed on the handle bars, it is out of the question that for the rider to hold a communications device while riding the bicycle. In addition, in most applications, it is very difficult to fit electronic equipment, including speakers and the like, within the tight confines of the helmet due to the construction of the helmet itself. In addition, the installation and removal of such equipment is also a challenge.

As is well known, Bluetooth is an industrial specification for wireless personal area networks (PANs). Bluetooth provides a way to connect and exchange information between devices, such as mobile phones, laptops, personal computers, printers, GPS receivers, digital cameras and video game consoles over a secure, globally unlicensed short-range radio frequency. One of the more prevalent applications of Bluetooth is the wireless control of and communication between a mobile phone and a hands-free headset that allows the transfer of sound data between the two devices.

The present assignee has a number of products that are commercially available and are marked to motorcycle riders. These products are typically wireless communications units that are adapted to be attached to motorcycle helmets and each includes a device that interfaces with the Bluetooth functionality of the user's mobile phone.

One segment of the industry that has not been addressed is the incorporation of a communications or entertainment system into a conventional bicycle helmet and therefore, there is a perceived need to provide such device that easily mounts to a conventional bicycle helmet.

### SUMMARY

In accordance with the present invention, a communications system is configured for use with a helmet that includes vent openings formed in an outer shell of the helmet. The system includes a main communications module that is configured to be attached to an exterior of the outer shell of the helmet. The main communications module includes a base portion that contains the electronics and another separate part that is mounted to the helmet by being passed through openings of the outer shell. The base portion is removably attached to the separate part that is mounted to the helmet. The base portion is attached to the separate part such that a location of the base portion can be adjusted relative to the separate part.

The system also includes a first audio component that is formed of an elongated body that has a flexible base portion and a speaker that extends outwardly from the base portion. The base portion includes a first mechanical attachment member for securely, yet releasably, attaching the first audio component to a second mechanical attachment member located inside of the outer shell of the helmet proximate one ear of a user. The first audio component is in communication with the main communication module.

The system also includes a second audio component that is formed of an elongated body that has a flexible base portion and a speaker and microphone that extend outwardly from the base portion. The base portion includes the first mechanical attachment member for securely, yet releasably, attaching the second audio component to the second mechanical attachment member located inside of the outer shell of the helmet proximate the other ear. The second audio component is in communication with the main communication module.

The first and second mechanical attachment members permit a location of the first and second audio components within the inside of the outer shell to be readily changed, thereby allowing a user to adjust the first and second audio components based on user preference.

The main communications module includes an electronic module that includes controls. The electronic module is configured to communicate with and/or operate as a digital media player, a radio tuner, a telephone, or a global positioning system (GPS) and to have intercom communications with another communication module using Bluetooth technology or other technology.

### BRIEF DESCRIPTION OF THE DRAWING FIGURES

The foregoing and other features and advantages of the present invention will be more readily apparent from the following detailed description and drawings of the illustrative embodiments of the invention wherein like reference numbers refer to similar elements and in which:

FIG. 1 is a left side elevation view of a communications system for use with a helmet, such as bicycle helmet;

FIG. 2 is a top plan view of the communications system of FIG. 1 that is used with a helmet;

FIG. 3 is a front view of the communication system of FIG. 1 that is used with a helmet;

FIG. 4 is a rear view of the communication system of FIG. 1 that is used with a helmet;

FIG. 5 is an exploded view of different components of an exemplary communications system for use with a helmet shown in cross-section;

FIG. 6 shows a first step in attaching a base cradle to a first type of helmet;

FIG. 7 shows a second step in attaching the base cradle to the helmet;

FIG. 8 shows a third step in attaching the base cradle to the helmet;

FIG. 9 shows a fourth step in attaching the base cradle to the helmet;

FIG. 10 shows a first step in attaching a base cradle to a second type of helmet;

FIG. 11 shows a second step in attaching the base cradle to the helmet;

FIG. 12 shows a third step in attaching the base cradle to the helmet;

FIG. 13 shows a fourth step in attaching the base cradle to the helmet;

FIG. 14 shows a fifth step in attaching the base cradle to the helmet;

FIG. 15 shows a first step in attaching audio components to the helmet;

FIG. 16 shows a second step in attaching audio components to the helmet;

FIG. 17 shows a third step in attaching audio components to the helmet;

FIG. 18 shows a fourth step in attaching audio components to the helmet;

FIG. 19 shows a first step in attaching an audio connector to the helmet;

FIG. 20 shows a second step in attaching an audio connector to the helmet;

FIG. 21 shows a third step in attaching an audio connector to the helmet;

FIG. 22 shows the step of releasing the attached audio connector from the helmet;

FIG. 23 shows the step of attaching an electronics module to the helmet;

FIG. 24 shows the step of disengaging the electronics module from the helmet;

FIG. 25 shows a first step in attaching a front spoiler member to the cradle;

FIG. 26 shows a second step in attaching the front spoiler member to the cradle;

FIG. 27 is a side elevation view of the components of the system of the present invention coupled to a helmet with an optional accessory;

FIG. 28 is front view of the assembly of FIG. 27; and

FIG. 29 is a bottom view of the electronics module.

### DETAILED DESCRIPTION OF EMBODIMENTS

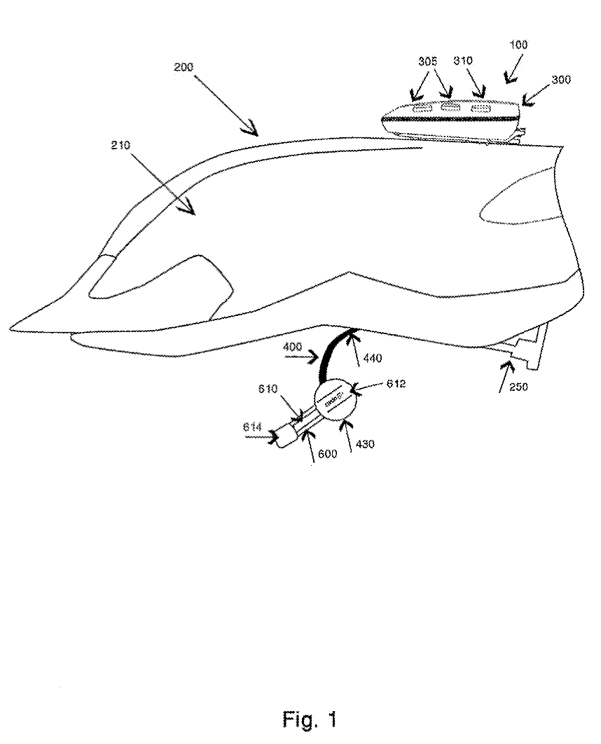

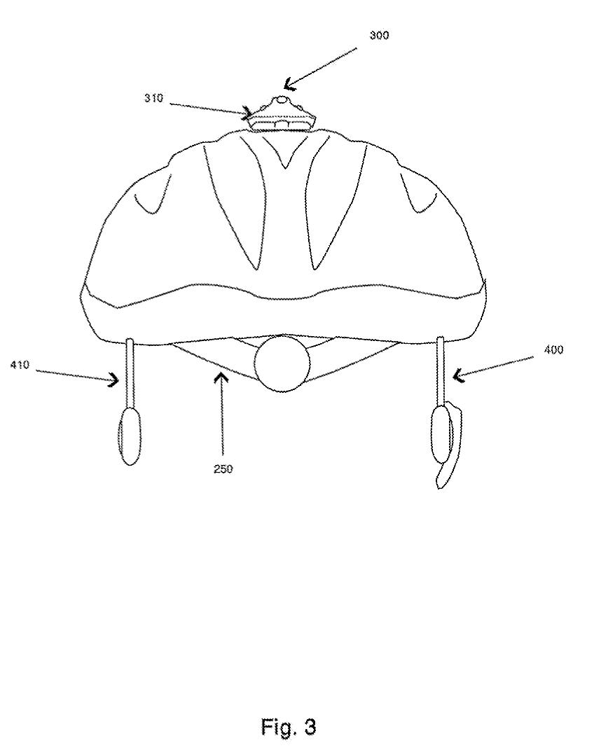

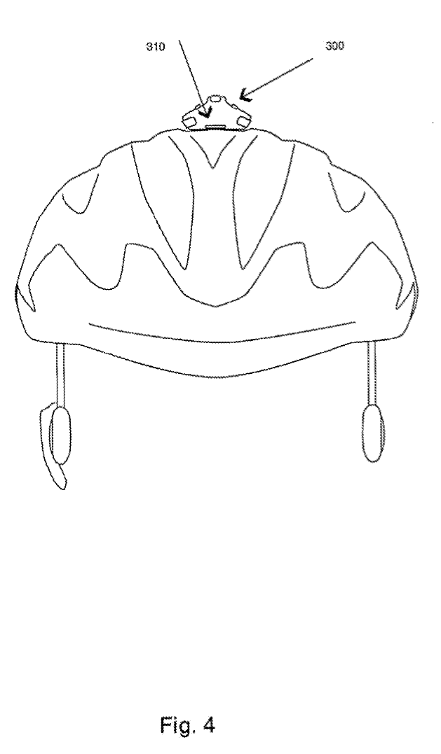

In accordance with one embodiment of the present invention, an electronic communications or entertainment system 100 for use with a helmet 200 is shown in FIGS. 1-5. While the helmet 200 that is illustrated in FIGS. 1-5 is a conventional bicycle riding helmet, it will be understood that the helmet 200 is not limited to being this type of helmet; but rather, the helmet 200 can be any number of other types of helmets that have similar construction such that the communications system 100 can be detachably mounted to the helmet 200.

As shown in FIGS. 1-5, the bicycle helmet 200 is typically formed of the basic components that work together to provide protection in the helmet 200; namely, an outer shell 210 and a retention system 250.

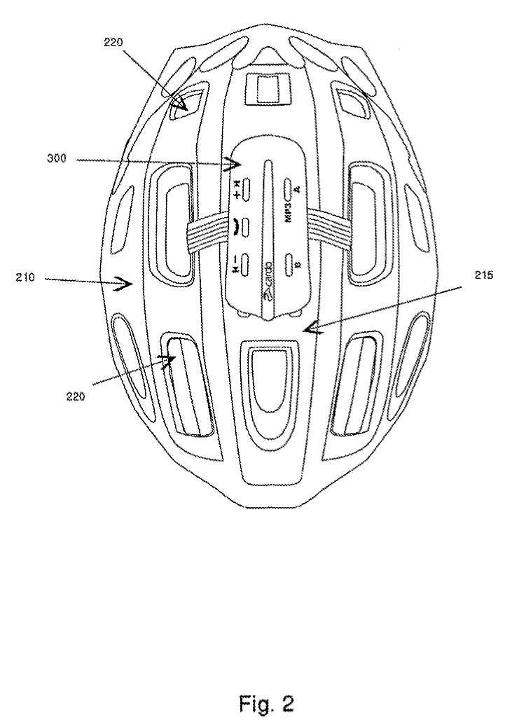

One of the other predominant characteristics of the helmet 200 is the inclusion of openings 220 within the outer shell 210 of the helmet 200. These openings 220 provide venting and airflow to the wearer's head without jeopardizing safety. The openings 220 can be in the form of elongated openings or slots formed in the outer shell 210. These openings 220 provide an aerodynamic look as well to the outer shell 210. The openings 220 are spread across the outer shell 210 of the helmet 200 and are thus located in different regions of the outer shell 210 including the top and sides of the helmet 200. The openings 220 can be formed adjacent one another and as shown in the top view of FIG. 2, a portion 215 of the outer shell 210 that is located between side-by-side openings 220 forms a support surface.

It will be appreciated that the helmet 200 described herein is merely one exemplary type of helmet and in no way limits the communications system 100 of the present invention which is configured to and intended for use with any number of different types of helmets, including the type shown herein as well as other types of helmets.

In accordance with the present invention, an electronic communications or entertainment system 100 is provided and is designed to be used with a conventional helmet like bicycle helmet, such as helmet 200. As described below, the system 100 is designed to be easily and securely mounted to the helmet 200, while at the same time, the system 100 can be easily removed from the helmet 200. For example, after use of the helmet, the user can simply remove and store the system 100 for a future use.

When the system 100 is in the form of a communications system 100, it is configured to allow communication with another component, such as a mobile telephone. For example and as described in detail below, the electronic communications system 100 can be configured to be part of a Bluetooth communications system in which the communications system 100 that is mounted to the helmet 200 communicates wirelessly with another device, such as a Bluetooth capable mobile telephone or other type of communication device. For example, the communications system 100 can communicate with another communications system 100 worn by a different person.

In the illustrated embodiment, the system 100 includes a base communications module 300 that contains the communication components of the system 100. The base communications module 300 includes a housing (base portion) 310 that stores the communication components as well as other electronic components that are part of the system.

The electronics of the module 300 also include an accessible control panel or controller that has a number of accessible controls 305 that allows the wearer to control the communications system and preferably includes a display, such as a display screen. For example, the module 300 includes a number of controls 305 that are accessible along an outer surface of the housing 310 with the illustrated base module 300 including buttons 305 or like that permit the user to operate the device. The control panel 305 is operatively connected to the printed circuit board via wires or the like. The control panel 305 includes a number of different buttons that control the functionality of the communications system 100.

In one embodiment, the control panel 305 can include a control button which when pressed anywhere within range of the other Bluetooth device (e.g., mobile phone) causes the power to be turned ON/OFF and allows the user to accept or initiate calls. In addition, the control panel 305 also includes a volume down button and a volume up button. The buttons include indicia to indicate their functionality. For example, a telephone symbol for the button that switches to telephone mode, a minus symbol for the button that decreases the volume and a plus symbol for the button that increases the volume.

The buttons or controls can allow the user to scroll through menus, make various selections and change the operating parameters of the device, vary different controls, such as volume, etc. As described below, when the module 300 is in the form of an entertainment system, the buttons can include traditional media buttons, such as a play button, a stop button, rewind, forward, etc.

The module 300 can also include a display which permits different content, including current settings and current operation modes, to be viewed by the user. The display can be located along a top surface of the module 300; however, other locations, such as one side, are equally possible.

In the illustrated embodiment, the housing 310 has an elongated shape to permit it to be easily mounted to the helmet 200 along the outer shell 210. Since the module 300 is, in the illustrated embodiment, mounted to the top of the outer shell 210, the shape of the housing 310 is preferably aerodynamic, like the outer shell 210 itself, so that it channels and does not excessively impede air flow along the outer shell 210.

In accordance with the present invention, different techniques can be used to mount the module 300 to the helmet 200. For example, the module 300 can include a lower base plate that is configured to mount to a complementary mounting structure that is part of the helmet 200.

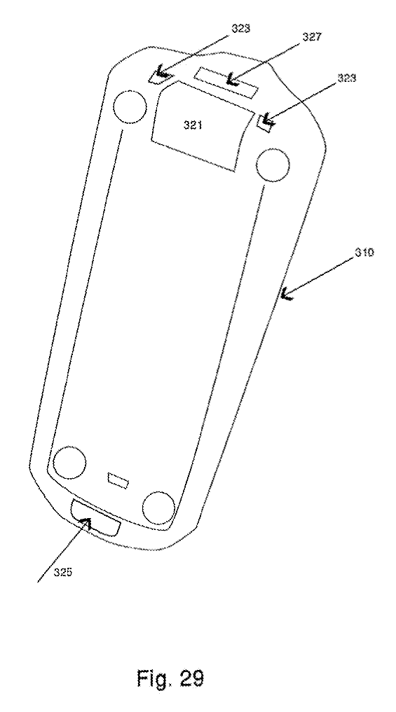

FIG. 29 shows an underside of the housing 310. The housing 310 has a recessed section 321 formed near one end thereof. The recessed section 321 provides an area at which the electronic connection between the module 300 and the connector 495 is provided. For example, some of the electronics of the module 300 can be accessible through the section 321 and in particular, electrical contacts can be formed along the floor of the recessed section or can represent the floor of the recessed section such that when the module mates with the cradle 355, the contacts of the connector 495 mate with and are placed in electrical contact with the contacts that are in the section 321 and associated with the module 321. In FIG. 29, the contacts and electronics are not shown in place.

Adjacent the recessed section 321, a pair of first locking sockets 323 are formed. Similarly, at the opposite end, a second locking socket 325 is formed. At this opposite end, a connector opening 327 is formed and can be covered by a cover or the like. The connector opening 327 provides access to a connector that can be part of the housing to optionally allow an external device to be connected thereto.

It will be appreciated that the module 300 includes electronics, including a printed circuit board, a battery, etc., that are disposed in a concealed location within the housing 310. The module 300 can operate in any number of different manners to provide communications functionality and/or entertainment functionality. For example, the electronics of the module 300 can be designed to communicate with a cellular phone or the like so that the user can both receive telephone calls and can make telephone calls using the module 300. In addition, the module 300 can be configured so as to be compatible with a global positioning device (GPS) device so that directions that are generated by the GPS device can be heard by the user (wearer of the helmet). The controller (software) of the module 300 can be programmed to include a number of different operating modes such as one where GPS generated directions take priority over other communications, such as cellular phone communications and entertainment transmissions and therefore, when GPS directions are generated, the user hears these directions, while other ongoing communications or transmissions are muted.

As mentioned herein, the module 300 can also function as a device that provides musical entertainment to the user and in particular, the module 300 can function as a digital media player (e.g., MP3 player) and can also include an FM tuner so as to allow the user to receive FM transmissions. The module 300 can also provide intercom communications with another module 300.

The controls associated with the module 300 permit the user to select from the different operating modes or to turn the module 300 on or off.

Another part of the communications/entertainment system 100 is pair of audio components that are also designed to releasably mount to the helmet 200 (e.g., inside of the outer shell 210 thereof). In the illustrated embodiment, a first audio component 400 is intended to be worn proximate the left side of the wearer's head and a second audio component 410 is intended to be worn proximate the right side of the wearer's head. The first and second audio components 400, 410 can be identical, similar or different from one another depending upon the particular application. In the illustrated embodiment, the first and second audio components 400, 410 are slightly different from one another in that the second audio component 410 includes a microphone 600, while the first audio component 400 does not.

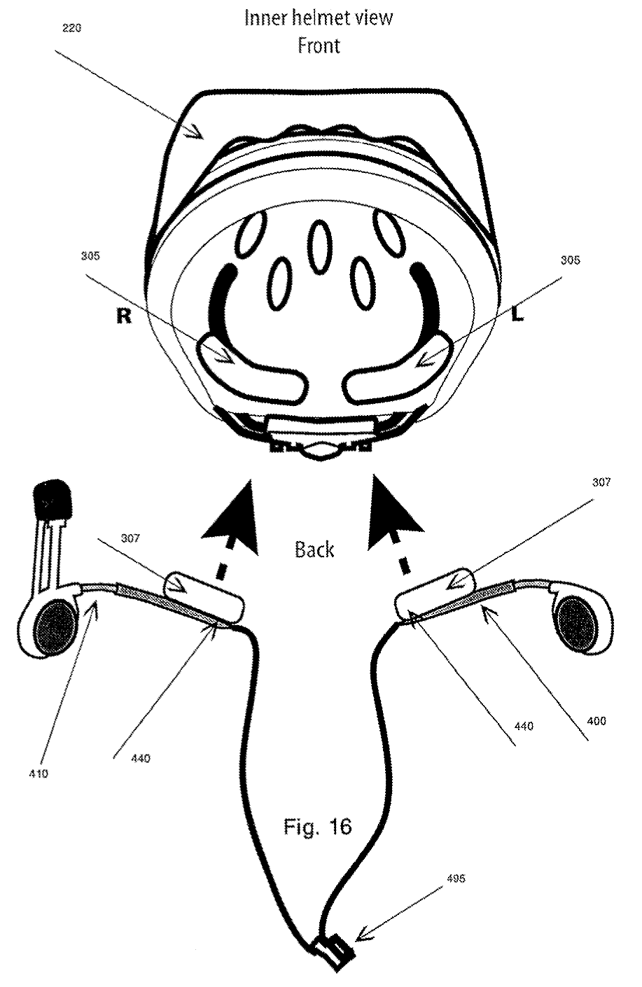

In the illustrated embodiment shown in FIGS. 1 and 16, the first and second audio components 400, 410 each includes a base or attachment portion 440 that can be coupled to the helmet 200 and a speaker 430 that depends therefrom. The speaker 430 is of a headphone type and can be either the type that is at least partially inserted into the user's ear, worn around the ear or is simply located proximate to but not necessarily in contact with the ear. In the illustrated embodiment, the speaker 430 has a round shape and is intended to be either placed proximate the wearer's ear. The speakers 430 hover above the ear and do not touch the ear of the wearer. This is in contrast to other headphone assemblies where the speaker component makes physical contact with the ears of the wearer. Physical contact with the ears can be irritating and lead to discomfort over time especially during motion of the wearer as during riding of a bicycle, etc.

The base 440 is preferably constructed of a material that has some flexibility to accommodate the normal wear and the normal forces that may be applied thereto during normal bicycle riding. By being formed of a flexible material, the base 440 can also be adjusted to allow better positioning of the speaker 430 relative to the ear. The base 440 can be an elongated hollow tube-like structure that attaches at one end to the speaker 430 and at the other end to the base 440 and is able to withstand normal forces and contact that occur during cycling. When the base 440 is formed from a flexible (pliable) material, the base 440 can be readily bent to allow more optimal positioning of the speaker 430 near the ear. The base 440 is also formed so that wires and the like can pass therethrough and be routed the length of the base 440 to connect the audio components, such as the speaker 430, to the other working components of the device 100.

The base 440 can thus be curved or bent as illustrated. For example, the base 440 can be bent to have generally a 90 degree angle which results in the speaker 430 being placed proximate the ear when the helmet 200 is worn. The degree of the angle can be altered by simply bending the base 440 along its length (when the connector is formed of a flexible material) to provide more optimal positioning of the speaker 430.

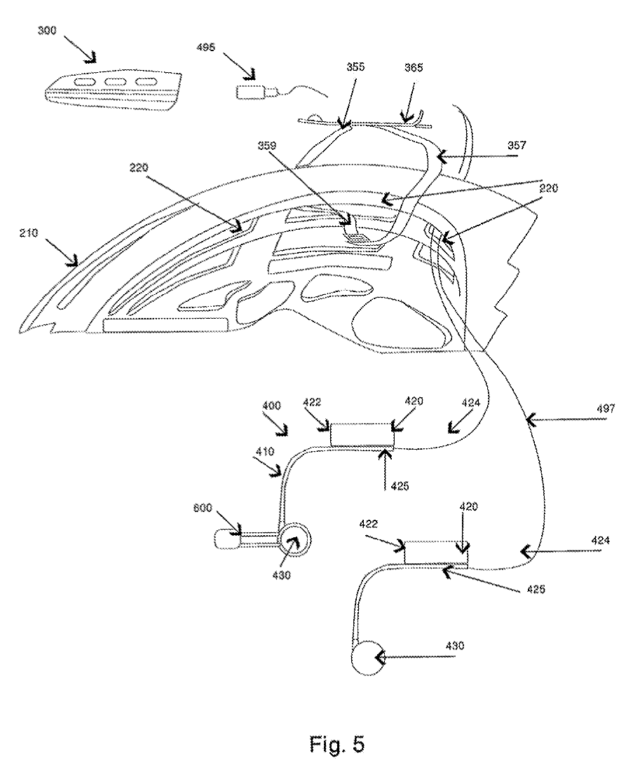

As shown in FIG. 5, the audio components 400, 410 can be electronically connected to the module 300 by means of wires and a connector 495. In particular, each audio component 400, 410 has one or more wires 497 extending therefrom (e.g., extending from the base 440) that terminate together in the connector 495. The connector 495 is designed to electronically connect the audio components 400, 410 to the module 300. For example, the connector 495 can be of a male and female type with the module 300 including a connector of the opposite type. The connector 495 can thus be plugged into the module 300 or otherwise mate therewith, thereby establishing an electrical connection between the two.

It will also be appreciated that alternatively, the audio components 400, 410 can communicate wirelessly with the module 300 and in this embodiment, an antenna or the like can be included and coupled to the base portion 440. For example and as shown, the antenna can be an elongated member (e.g., pencil or wire like in nature) that is attached to the base portion 440. The antenna can be used to receive and/or transmit signals from the audio component 400, 410 to another component, such as the module 300. It will also be appreciated that instead of an external antenna, an internal antenna can be used.

The difference between the audio component 400 and the audio component 410 is that the first audio component 400 includes the microphone 600 that has a flexible boom 610 that extends outwardly from the speaker 430. The microphone boom 610 is an elongated structure that extends forwardly toward the front of the helmet 200 and includes a first end 612 that is attached to the speaker 430 and an opposing second end 614 that contains the microphone unit into which the wearer speaks. The boom 610 is formed of a flexible material so as to allow optimal positioning of the microphone unit to the wearer's mouth.

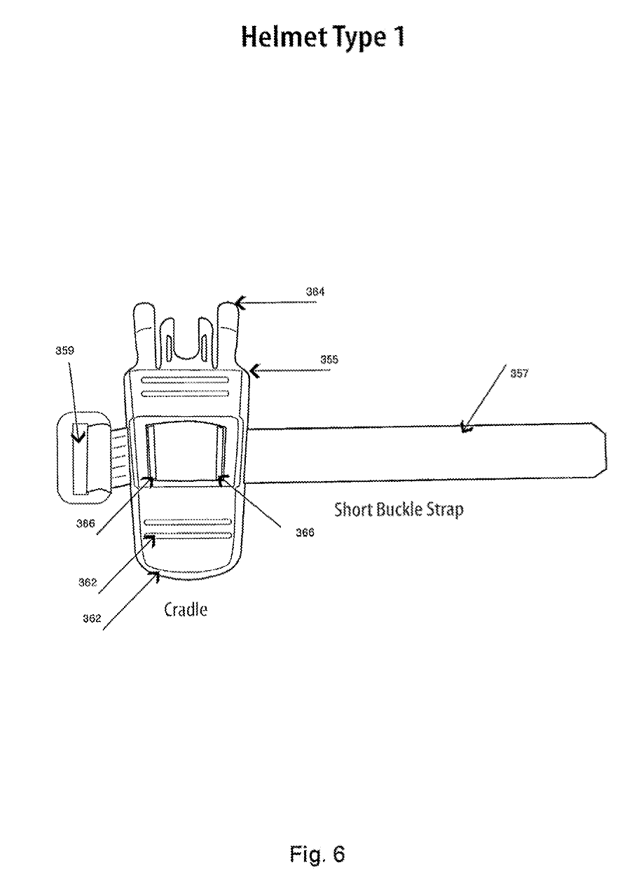

With reference to FIGS. 5 and 6, in the illustrated embodiment, the module 300 is constructed to be mounted to the helmet 200 using a base or cradle 355 that is detachably attached to the helmet 200 and is separate from the module 300. As described herein, the cradle 355 is physically attached to the helmet 200 using conventional means, such as an elongated flexible strap 357 that has two ends with a free first end and a second end that contains a fastening element 359. The fastening element 359 can be in the form of a buckle type fastener. The strap 357 can be formed of any number of suitable materials, including synthetic materials, such as nylon, etc. The strap 357 can include one or more fastening elements. For example, the fastening element can be in the form of pieces of hook and loop material that permit the strap 357 to be attached to itself to form a continuous loop by folding over the strap 357 and pressing two portions of the strap 357 together as shown.

As described herein, the components 300, 400, 410 are intended to mate together and form a kit that is then easily assembled by the user in the manner described herein.

As shown in FIGS. 5 and 6, the cradle 355 is partially adjustably disposed along the strap 357 so that the position of the cradle relative to the strap 357 can be adjusted. However, as described herein, the strap 357 can include a pair of stops (protrusions) 375 formed along its length and spaced apart and configured to limit lateral movement of the cradle 355 along the length of the strap 357.

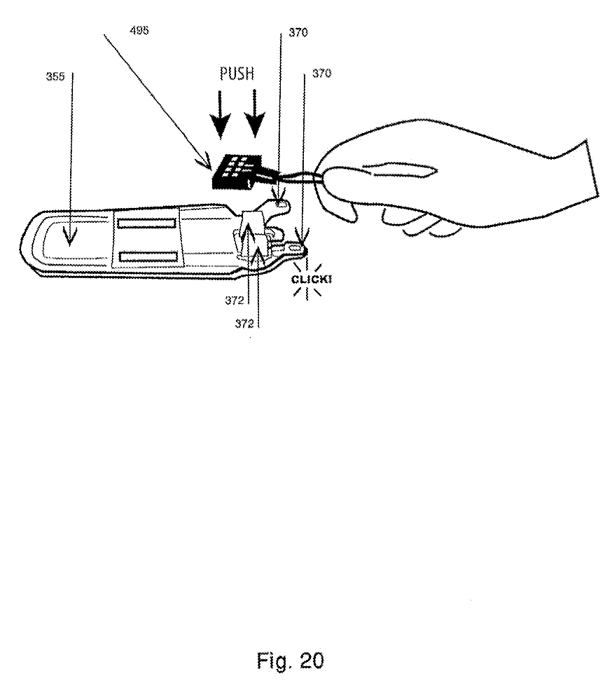

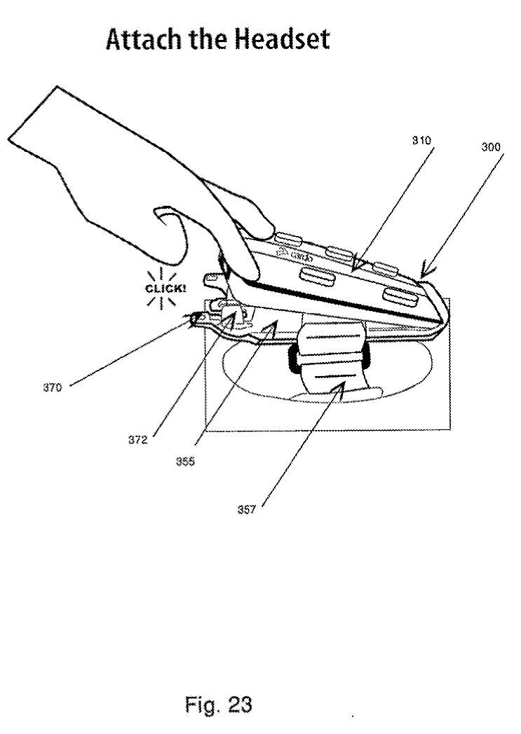

The cradle 355 has a top surface 360 and a bottom surface 362 that rests on the helmet 200. The cradle 355 also has a front end 362 and an opposing back end 364. Along the top surface 360, the cradle 355 has a center recessed portion 347 that is configured to receive the module 300 in such a way that the module 300 is securely held in place and in a locked manner along the top surface 360. As shown best in FIGS. 20-23, the cradle 355 has a pair of intermediate slots 366 formed therein. The slots 366 pass completely through the structure and permit the strap 357 to pass therethrough.

The cradle 355 also includes a coupling or locking mechanism that is designed to engage with complementary features formed as part of the housing 310 of the module 300. For example, the locking mechanism can be in the form of a pair of flexible locking fingers 370 that are located at the end 364. The locking fingers 370 are elastic fingers that can flex. In addition, at the end 364, the cradle 355 also includes a pair of flexible upstanding tabs or fins 372 that are located between the fingers 370. The tabs 372 (see FIG. 20) extend upwardly from the top surface and can be substantially parallel to one another. At the front end 362, the cradle 355 includes a locking tab 380.

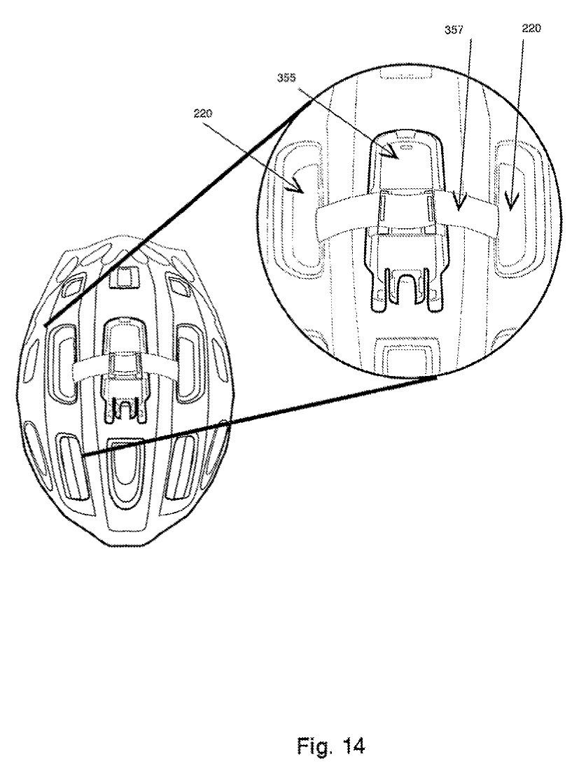

FIGS. 6-24 show various steps in mounting the equipment of the present invention to helmet 200.

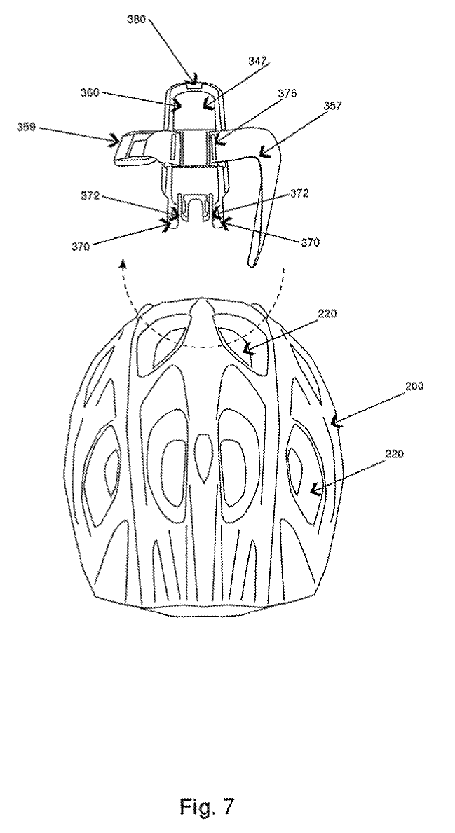

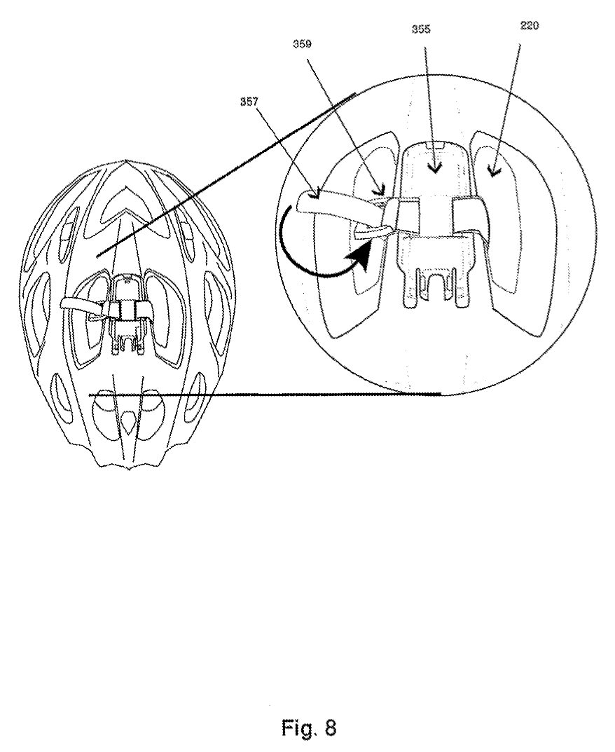

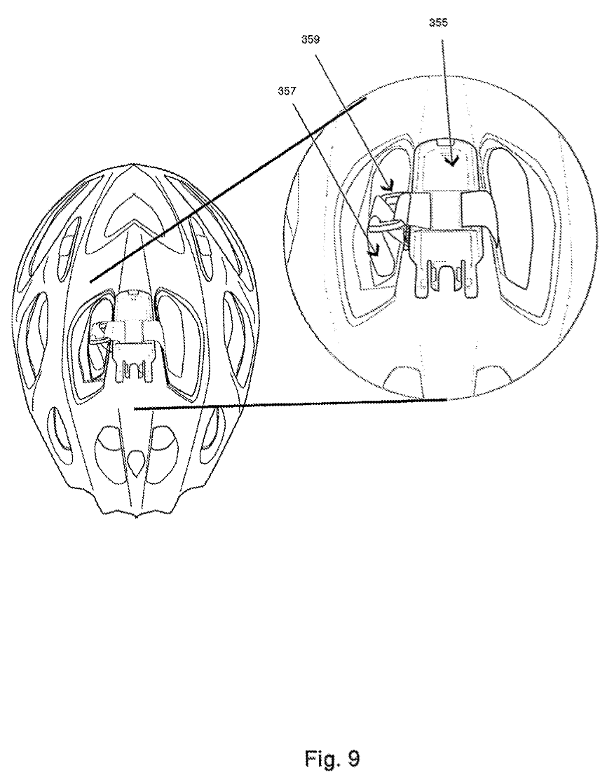

FIG. 6 shows the cradle 355 being installed on helmet 200 which is of a first type. The strap 357 is fed through the slots 366 with the fastening element 359 being disposed on one side of the cradle 355 and the free strap end on the other side. FIG. 7 shows the cradle 355 being installed on the helmet 200 with the bottom surface thereof facing the helmet 200. The arrow in FIG. 7 shows how (direction) the strap 357 is fed through the slots 366 to fasten the cradle 355 to the helmet 200. In particular, the free end of the strap 357 is passed through one slot (opening) 220 and extends across the inside of the helmet 200 before then being fed up through another slot 220. FIG. 8 shows the free end of the strap 357 passing through the fastening element 359 and FIG. 9 shows the free end being back down on top of itself such that the free end of the strap is pulled tight and fastened to another portion of the strap 357 that is located within the interior of the helmet 200. For example, the strap 357 can contain hook and loop material that permits the strap to be securely attached to itself. This results in the cradle 355 being securely attached to the helmet 200.

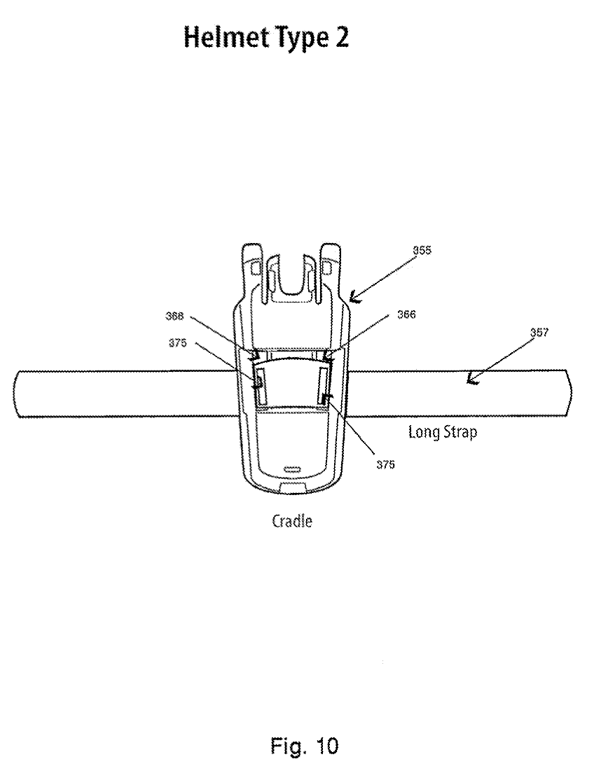

FIGS. 10-14 show an alternative method for attaching the cradle 355 to a helmet 200 that is of a different type. As shown in the top view of FIG. 10, the strap 357 used in this embodiment does not include fastening element 359 at one end but instead includes other fastening elements, such as hook and loop material along its length. The strap 357 is fed through the slots 366 such that the free ends of the strap 357 are located beyond the two sides of the cradle 355. FIG. 10 shows that the strap 357 can include spaced stops (protrusions) 375 that limit the lateral movement of the strap 357 relative to the cradle 355 due to interference between the stops 375 and the body of the cradle.

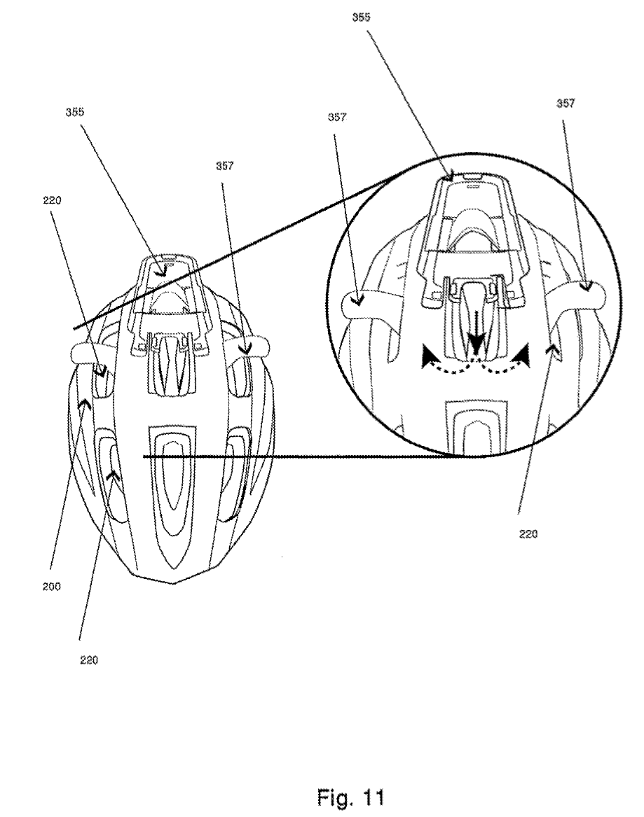

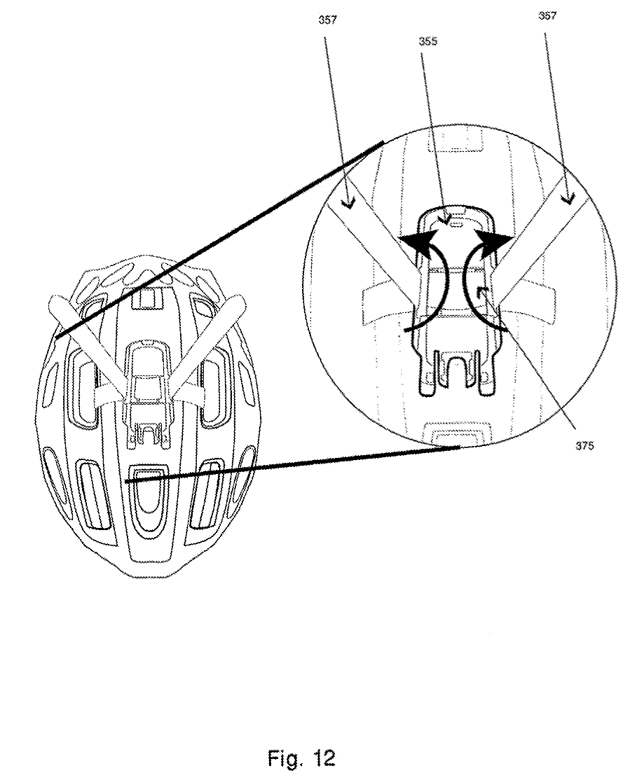

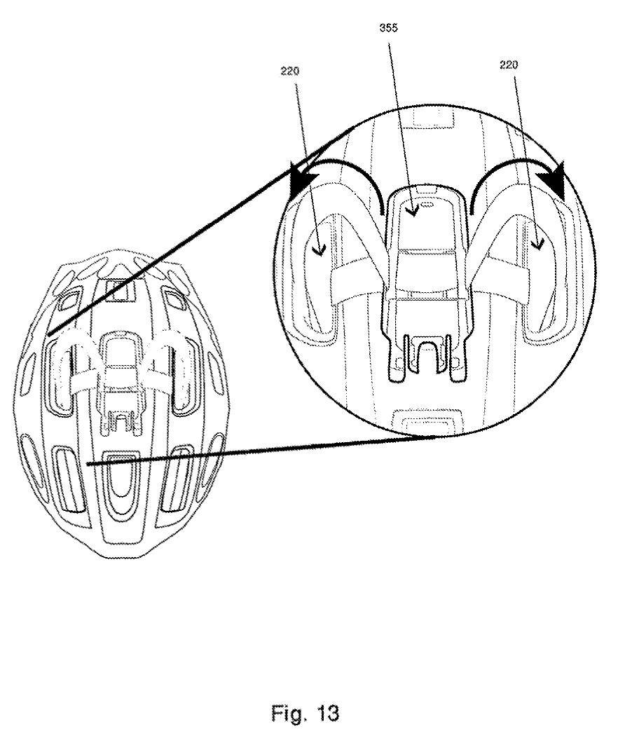

FIG. 11 shows the cradle 355 being disposed on the helmet 200 with the bottom surface facing the helmet 200. Both free ends of the strap 357 are passed through one common opening 220 that is generally under the cradle 355. Once the two free ends pass through the common opening 220, the two free ends are then pulled laterally in opposite directions and looped up through other openings 220 of the helmet 200 that are proximate but laterally offset from the common opening 220. As shown in FIG. 11, the free ends of the strap are located above the helmet. As shown in FIG. 12, the free ends of the strap 357 are then fed back through the body of the cradle 355. This can be accomplished by feeding the free ends of the strap 357 through either the same slots 366 (a double pass through of straps within the slot 366) or through other slots that can be formed in the cradle 355 between the slots 366 and the peripheral edge of the cradle body. As shown in FIGS. 12-13, once the free ends of the strap 357 pass through the cradle body, the free ends are then routed back through the other openings 220 that they previously were passed through (one either side of the common opening 220) and the free ends are then pulled tight and secured to the strap 357 using a mechanical fastener, such as hook and loop material that is along the strap 357. This results in the cradle 355 being securely attached to the helmet in a manner in which the cradle 355 does not move.

In both attachment methods, the recessed center portion of the cradle 355 is not obstructed and can freely receive the module 300.

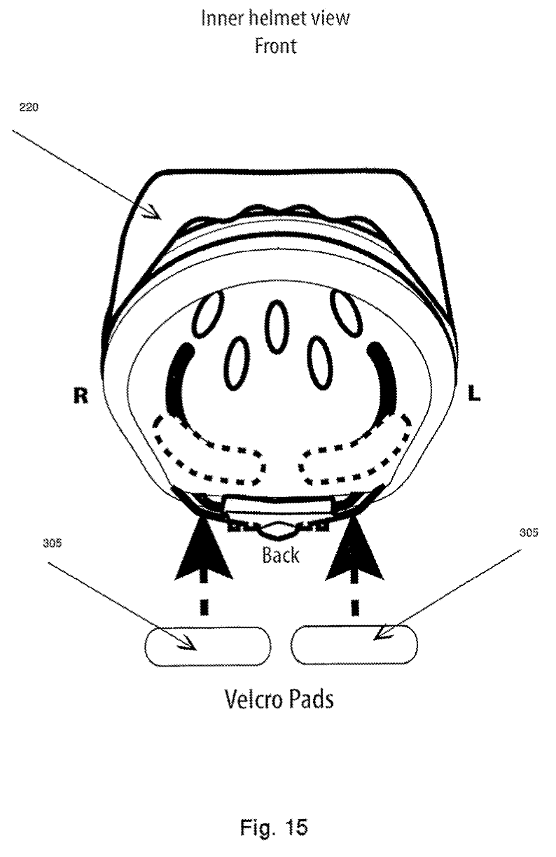

FIGS. 15-18 show exemplary steps for attaching the audio components of the device to the helmet 200. For example, FIG. 15 shows the inside of the helmet 200 and the use of first fastening elements 305 that are securely attached along the inside of the helmet 200 near or at the back section thereof. Any number of different fastening elements can be used; however, in the illustrated embodiment, the first fastening elements 305 are in the form of a pair of pads made of hook and loop material. The pads can include an adhesive face that is used to attach them to the helmet.

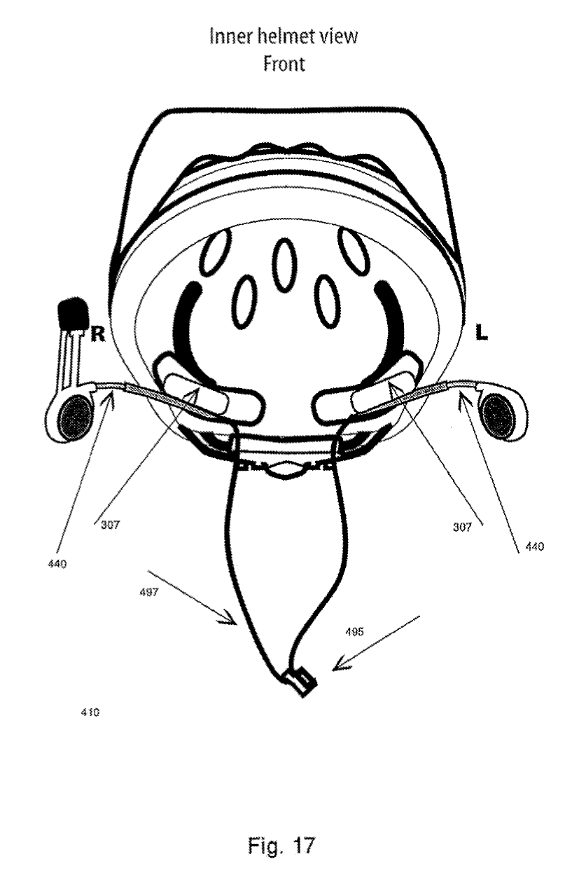

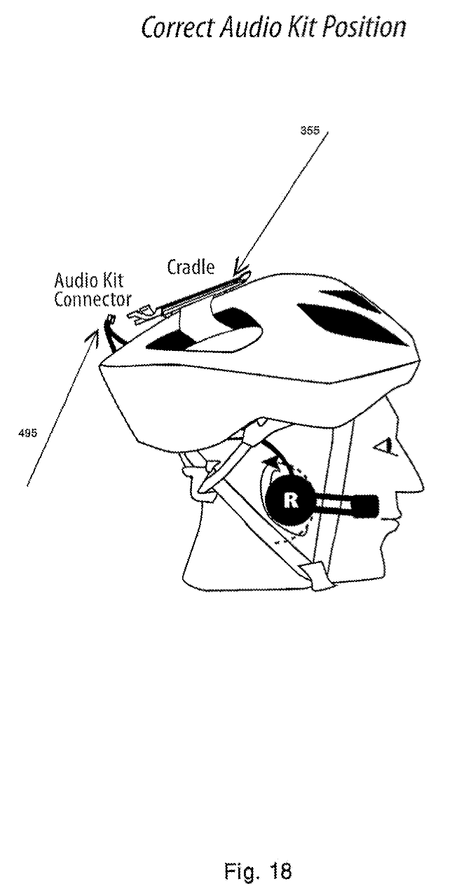

FIG. 16 shows that after a predetermined amount of time, such as 5-10 minutes, the first and second audio components 400, 410 are attached to the helmet 200. For example, the connectors 440 of the components 400, 410 can include complementary second fastening elements 307 that mate with the first fastening elements 305. For example, the second fastening elements 307 can be in the form of pads of hook and loop material that are secured to the connectors 440. FIG. 17 shows the audio components 400, 410 attached to the inside of the helmet 200 with the connector 495 being outside the helmet 200. FIG. 18 also shows the components relative to the helmet 200.

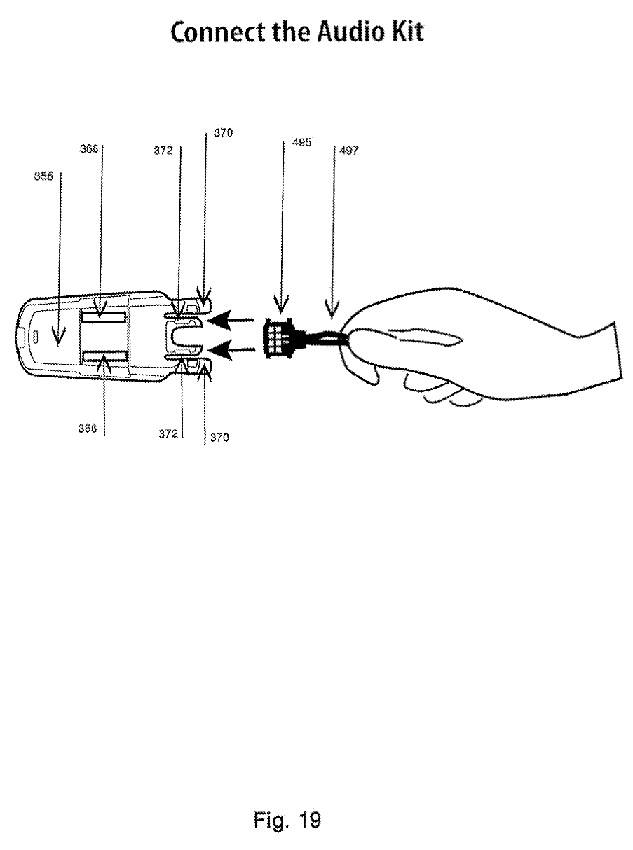

FIGS. 19-22 show exemplary steps in attaching the audio kit to the cradle 355. The connector 495 that is located at the end of the wires 497 are inserted into the back end 364 of the cradle 355 and is securely attached between the flexible fins 372. As shown in FIGS. 19-20, the connector 495 can snap-fittingly mate with the cradle 355. The connector 495 can include side notches that receive the fins 372. The fins 372 thus flex into place within the notches leaving the wires 497 extending from the unit. An audible click is heard to indicate that the connector 495 is locked in place and is secured to the cradle 355, thereby permitting connection of the speakers and microphone of the system to the main module 300 when the main module 300 is installed in the cradle 355.

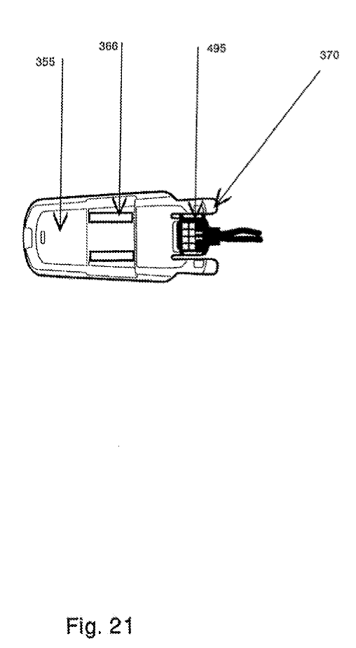

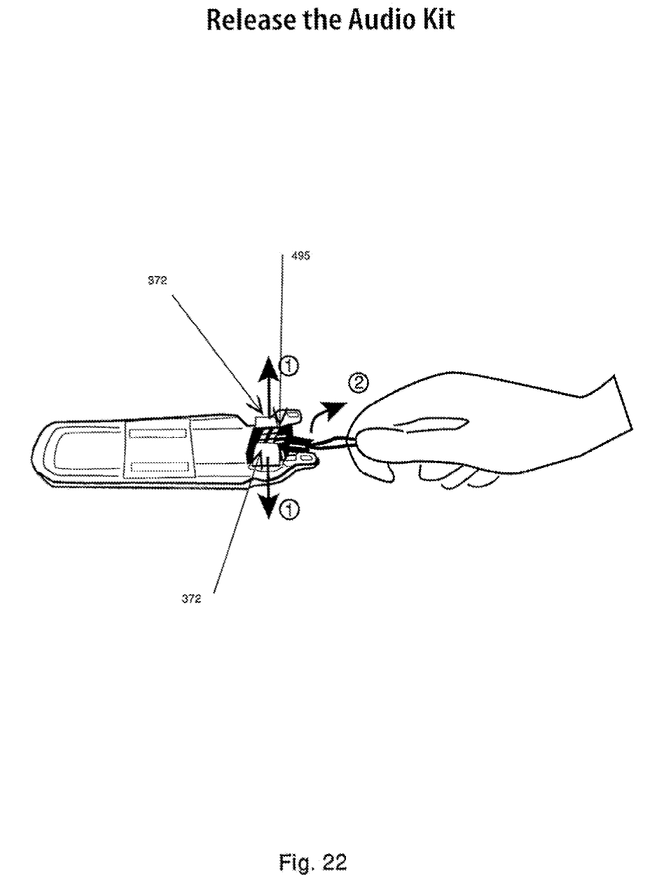

FIG. 21 shows the connector 495 in the installed position. FIG. 22 shows the release of the connector 495 by simply flexing the fins 372 outwardly as indicated by the arrows and then pulling the connector 495 away from the cradle 355 as indicated by the arrow.

As shown in FIGS. 6, 23-24 and 29, the cradle 355 interlockingly engages the housing 310 of the main module 300 by first inserting the locking tab 380 into the socket 325 formed in the housing 310 (resulting in the tab 380 being caught therein). The main module 300 is then lowered into the recessed section of the cradle 355 such that the fins 372 are received into slots that are formed in the recessed section 321 and then the locking protrusions 319 are received into the sockets 323, thereby resulting in the housing 310 being snap-lockingly mated to the cradle 355 at its both ends.

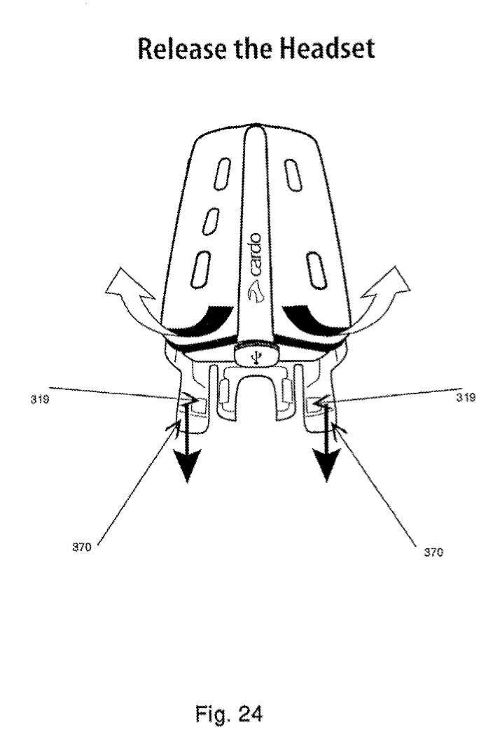

As shown in FIG. 24, to disengage the main module 300 from the cradle 355, the user simply pushes down the resilient fingers 317 to thereby disengage the locking protrusions 317 from the sockets 323 and permit the housing 310 to be lifted from the cradle 355 by lastly disengaging the tab 380 from the socket 325.

Audible and tactile indicators are provided to alert the user that the proper fit is achieved. For example, the snap-locking mechanism is designed so that when components mate together, an audible clicking noise is heard. In addition, the user will often feel the clicking action between the two parts. These two events confirm to the user that the two parts have been mated together.

It will be appreciated that the module 300 can be attached to the helmet 200 using different techniques than the ones described hereinbefore. For example, the base portion (housing 310) can have any number of different constructions including a clip-like construction that is constructed to mate with the outer shell 210 as by engaging one or more openings 220 formed in the outer shell 210. In addition, the helmet and module can include complementary fastening elements including but not limited to the use of a buckle type fastener or button type fastener or clasp type fastener, or a snap-fit attachment between the module 300 and the outer shell 210.

In another embodiment, the helmet 200 can be specially constructed so that it is complementary to the module 300 and more specifically, the outer shell 210 can be formed to include locking features that mate with locking features that are part of the module 300. For example, the bottom or base of the module 300 can include locking prongs or tabs that interlockingly mate with complementary features formed in the outer shell 210. In this manner, a snap-fit can be formed between the module 300 and the helmet 200; however, the module 300 can be removed at any time by disengaging the module 300 from the helmet 200. In this embodiment, the helmet 200 and system 100 can be marketed and sold together.

Since the mechanical attachment (hook and loop) between the audio components 400, 410 and the helmet 200 and between the main module 300 and helmet 200 is of a releasable type, the components 400, 410 and main module 300 can be easily removed from the helmet 200.

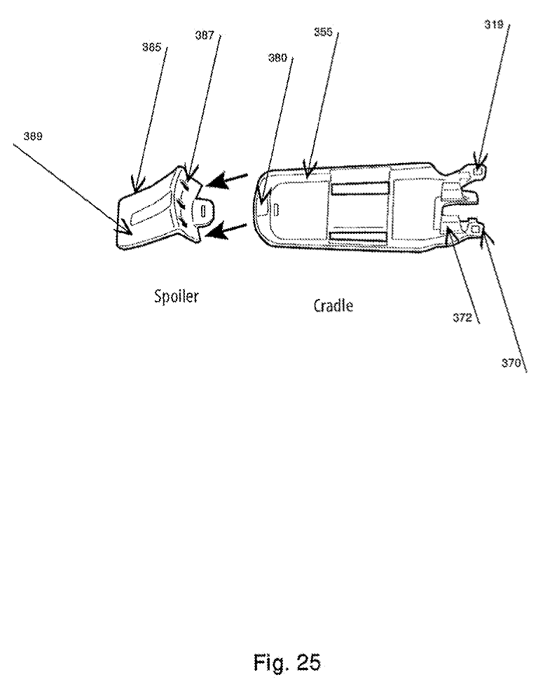

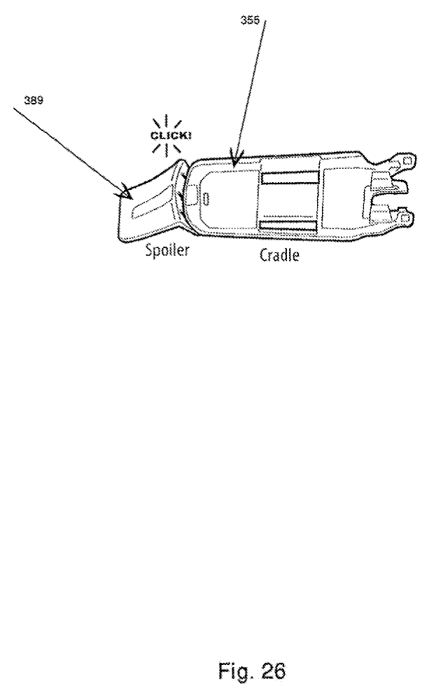

FIGS. 25-26 show the cradle 355 with an additional feature in the form of a front spoiler member 385.

It will be appreciated that the front spoiler member 385 can be an integral, shaped part of the cradle 355 in that it is formed at a front end of the base plate 309. The front spoiler member 385 has an upwardly turned lip portion 387 that at least partially covers the front end of the module 300 (FIG. 26). The front spoiler member 385 is constructed to prevent the components of the present invention from disconnecting from the helmet or helmet movement due to obstacles. For example, if the bicycle rider is riding under a tree, a branch can become lodged between the module 300 and the helmet and as a result, the module 300 can become dislodged and fall from the helmet or the helmet can become stuck onto the branch, thereby potentially injuring the rider.

However, as shown, the front spoiler member 385 can be a separate part that is mated to the cradle 355 using a mechanical attachment. For example, a snap-fit can be used to attach the front spoiler member 385 to the cradle 355. By installing the front spoiler member 385, the module 300 is shielded from possible obstructions and is protected from being accidentally dislodged due to a striking force.

As shown in FIG. 25, the front spoiler member 385 includes a first section 387 that detachable mates with the front end of the base plate 309 and a second section 389 that extends from the first section 387 and acts as the spoiler. The first section 387 and second section 389 are joined to one another so as to form a V or wing-shaped construction, with the second section 389 having a greater length than the first section 387. The second section 389 thus represents a tongue that extends downwardly and outwardly from the first section 387. Both the first and second sections 387, 389 can be at least partially arcuate shaped.

An inner surface or face of the first section 387 is the portion that is detachably attached to the front end of the base plate 309. When attached, as shown in FIG. 13, the top edge of the first section 387 rises above the front end of the base plate 309. This permits the first section 387 to at least partially cover the module 300 (as it is captured within the base plate 309) to prevent or reduce the chance that the module 300 is dislodged from the cradle 355. The inner surface of the first section 387 can include fastening features that mate with complementary fastening features associated with the front end of the cradle 355. The first section 387 can include a tab portion 391 that attached to the underside of the cradle 355 (e.g., snap-fit).

The second section 389 can seat against or remain slightly spaced from the top surface of the helmet to which the cradle 355 is attached. The sloped nature of the second section 389 can act as a deflector that causes any object that impacts the second section 389 to be deflected away from the module 300.

The front spoiler member 385 is thus detachably connected to the cradle 355 and can be easily installed and removed.

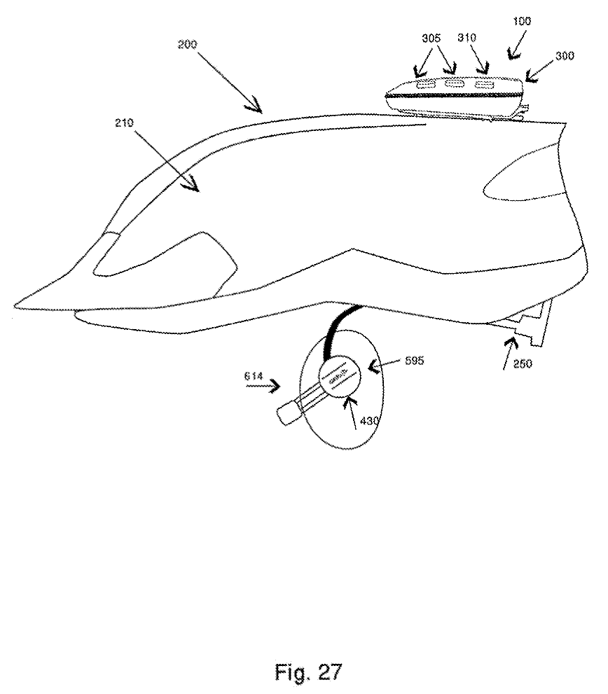

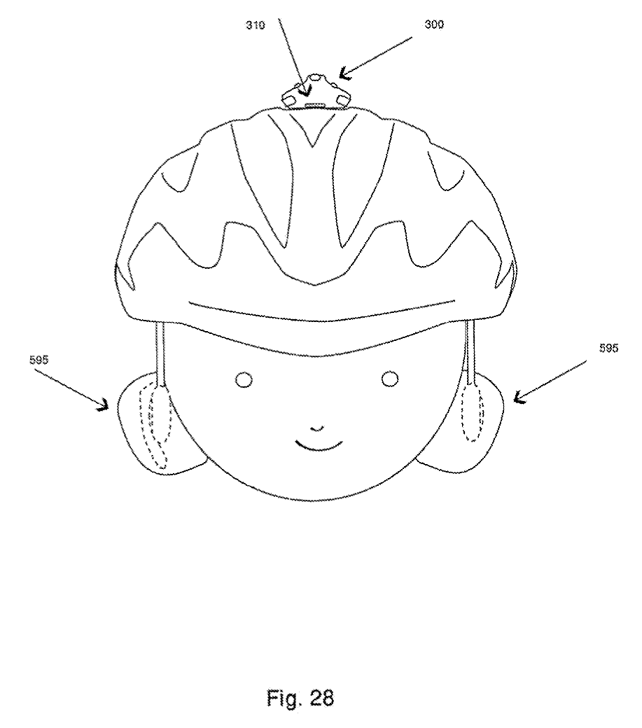

FIGS. 27 and 28 show another aspect of the present invention in that a noise protector cover 595 is provided to cover the audio components of the present invention. In particular, the speaker and microphone boom can be covered by a noise protector cover 595 that is formed of a plastic material and is shaped to prevent audio interference in high speed riding. The cover 595 can have a concave shape. It is cover the gap between the audio component 430 and the ear without touching user's face.

The communication systems disclosed herein are thus suitable for use with a bicycle style helmet that includes openings within the hard outer shell of the helmet. The components of the communication system can be easily attached to the outer shell and provide a complete communication system that offers the user a multimedia experience, including a digital music player, a radio, a navigation system, a GPS system, cell phone, intercom to other module, etc., all the can be controlled by a single module that is directly attached to the helmet.

In addition, as disclosed herein, the helmet itself can be constructed to be complementary to the main module and the audio components to allow the various components to be attached to the helmet. For example, the helmet can include integral fastening features that permit the components to be attached to the helmet. Besides snap-fit fastening means, as described herein, the helmet can include locking slots formed of two opposing guide rails that receive a protrusion or tab that is part of the component. The component mates with the helmet by sliding the protrusion into the locking slot, thereby locking the component to the helmet. The protrusion can include a locking tab or the like that is configured to lock the component to the helmet. In one embodiment, the pair of opposing guide rails can be in the form of opposing L-shaped rails that define a locking slot between one leg thereof and the outer shell 210. The protrusion can be a curved structure depending upon the location on the helmet where the component mates with the helmet. In this manner, to lock the respective component to the helmet, the locking protrusion (tab) is slid in one direction into the locking slot.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different points set forth below may be combined various ways in further accordance with the present invention.

What is claimed is:

1. A communications system for a helmet that includes vent openings formed in an outer shell thereof comprising:
a main communications module that is configured to be attached to an exterior of the outer shell of the helmet;
a cradle that is securely attached to the outer surface of the helmet and interlockingly mates with the main communications module;
a first audio component that is formed of an elongated body that has a flexible base portion and a speaker, wherein the base portion includes a first mechanical attachment member for securely, yet releasably, attaching the first audio component to an inside of the helmet proximate one ear of a user, the first audio component being in communication with the main communication module; and
a second audio component that is formed of an elongated body that has a flexible base portion and a speaker and microphone formed, wherein the base portion includes the first mechanical attachment member for securely, yet releasably, attaching the second audio component to the inside of the helmet proximate the other ear and mouth, the second audio component being in communication with the main communication module.

2. The communications system of claim 1, wherein the base portion is formed of a flexible synthetic material and includes the speaker at one end.

3. The communications system of claim 2, wherein the first mechanical attachment member comprises a hook and loop material that mates with complementary hook and loop material that is located along the inside of the helmet.

4. The communications system of claim 3, wherein the base portion comprises a tubular structure and the base portion comprises a flexible strip of hook and loop material.

5. The communications system of claim 1, wherein the first and second audio components are electronically connected to the main module by wires that extend along the interior of the helmet and terminate in a common first connector that extends through one opening formed in the outer shell and mates with a second connector that is part of the main module.

6. The communications system of claim 1, wherein the main module is received within a recessed section of the cradle and is mechanically coupled thereto in a snap-fit manner.

7. The communications system of claim 8, wherein a bottom surface of the main module includes first coupling members and the cradle includes second coupling members that mate with the first coupling members for snap-fittingly mating the main module to the cradle.

8. The communications system of claim 7, wherein the cradle includes a pair of flexible locking fingers with protrusions that engage openings formed in the main module for releasably locking the main module to the cradle.

9. The communications system of claim 1, wherein the cradle includes a pair of slots that receive a flexible strap for securely attaching the cradle to the helmet.

10. The communications system of claim 9, wherein the slots are located in a recessed center section of the cradle and permit the cradle to be attached to the helmet and the flexible strap includes hook and loop material.

11. The communications system of claim 9, wherein the flexible strap passes through at least a pair of openings formed in the outer shell and being attached to itself to form a continuous loop.

12. The communications system of claim 1, wherein one of the first and second audio components includes an adjustable microphone that is operatively connected to the main communications module.

13. The communications system of claim 1, wherein the main communications module comprises an electronic module that includes controls.

14. The communications system of claim 13, wherein the electronic module is configured to communicate with and/or operate as a digital media player, a radio tuner, a telephone, or a global positioning system (GPS).

15. The communications system of claim 1, wherein the main communications module is configured to communicate with another device using Bluetooth technology or other technology.

16. The communications system of claim 15, wherein the module is configured to have at least communication ability to one of a digital media player, a radio tuner, a navigation system, and a cellular phone.

17. The communications system of claim 1, wherein the cradle includes flexible fingers that permit release of the main communications module.

18. The communications system of claim 1, wherein the cradle includes flexible upstanding fins that receive an electrical connector therebetween, the electrical connector providing an electrical connection between the main communications module and the first and second audio components.

19. The communication system of claim 18, wherein a snap-fit is achieved between the electrical connector and the cradle.

20. The communication system of claim 1, wherein the main communications module interlockingly engages the cradle at both ends thereof.
